(19) United States
(12) Patent Application Publication
(10) Pub. No.: US 2026/0170889 A1
(43) Pub. Date: Jun. 18, 2026

(54) METHOD TO FORECAST FILTER CONGESTION STATUS

(71) Applicant: FCA US LLC, Auburn Hills, MI (US)

(72) Inventors: Siva Ganesh Palanisamy, Chennai (IN); Jaya Lakshmi N, Chennai (IN)

(21) Appl. No.: 18/983,697

(22) Filed: Dec. 17, 2024

(51) Int. Cl. G07C 5/08; B60H 3/06

(52) U.S. Cl. CPC G07C 5/0825; B60H 3/0608; B60H 2003/0683

(57) ABSTRACT

A system for displaying a clogged status for a vehicle air filter. The system may include an air filter configured to filter air in a passenger cabin, a blower in communication with the air filter, a plurality of sensors, including an air flow rate sensor, an air quality sensor, an sound sensor, an differential pressure sensor, and an temperature sensor, and one or more processors configured to receive a plurality of signals from the air flow rate sensor, the air quality sensor, the sound sensor, the differential pressure sensor, the blower, and the temperature sensor, and calculate a clogged status of the air filter based on the plurality of signals received from the sensors. The system may further include a display configured to receive an output from the one or more processors based on the clogged status of the air filter.

### FIELD

The present disclosure relates to a vehicle having a HVAC system that is configured to monitor and display air filter status.

### BACKGROUND

This section provides background information related to the present disclosure which is not necessarily prior art.

Vehicle HVAC systems may include an air filter for filtering air before it is introduced into the passenger cabin. These air filters may need to be periodically replaced to maintain healthy air quality in the passenger cabin and optimal performance of the vehicle HVAC system. However, it is not always apparent to the vehicle operator when these air filters should be changed, resulting in ineffective air filters remaining in use or effective air filters being replaced earlier than necessary.

### SUMMARY

This section provides a general summary of the disclosure, and is not a comprehensive disclosure of its full scope or all of its features.

According to a first aspect of the present disclosure, there is provided a method for displaying a clogged status for a vehicle air filter, including determining, by at least one processor of the vehicle, an air flow rate through the air filter, determining, by the at least one processor, an air quality level of a passenger cabin, determining, by the at least one processor, an HVAC noise level for the passenger cabin, determining, by the at least one processor, a differential pressure at the air filter, determining, by the at least one processor, a power level for a blower in communication with the air filter, determining, by the at least one processor, a temperature settling time for the passenger cabin, calculating, by the at least one processor, a clogged status of the air filter based on at least one of the air flow rate, air quality level, HVAC noise level, differential pressure, power level for a blower motor, and temperature settling time, and displaying the clogged status on a display.

According to the first aspect, calculating a clogged status of the air filter is based on the air flow rate, air quality level, HVAC noise level, differential pressure, power level for a blower motor, and temperature settling time.

According to the first aspect, the at least one processor is part of an Electronic Control Unit (ECU) in the vehicle.

According to the first aspect, determining, by the at least one processor, the air flow rate through the air filter further includes receiving, by the at least one processor, one or more signals from one or more air flow rate sensors, the one or more signals indicating a current air flow rate through the air filter.

According to the first aspect, determining, by the at least one processor, the air quality level of a passenger cabin further includes receiving, by the at least one processor, one or more signals from one or more air quality sensors, the one or more signals indicating a current air quality level in the passenger cabin.

According to the first aspect, determining, by the at least one processor, the HVAC noise level for the passenger cabin further includes receiving, by the at least one processor, one or more signals from one or more sound sensors, the one or more signals indicating a current HVAC noise level in the passenger cabin.

According to the first aspect, determining, by the at least one processor, the differential pressure at the air filter further includes receiving, by the at least one processor, one or more signals from one or more differential pressure sensors, the one or more signals indicating a current differential pressure at the air filter.

According to the first aspect, determining, by the at least one processor, the power level for the blower further includes receiving, by the at least one processor, one or more signals from the blower in communication with the air filter, the one or more signals indicating a current blower power level.

According to the first aspect, determining, by the at least one processor, the temperature settling time for the passenger cabin further includes receiving, by the at least one processor, one or more signals from one or more temperature sensors, the one or more signals indicating a current temperature in the passenger cabin, and calculating, by the at least one processor, a current temperature settling time based on the one or more signals from the one or more temperature sensors over a predetermined range of time.

According to the first aspect, calculating a clogged status of the air filter further includes comparing, by the at least one processor, each determined value to a predetermined threshold value.

According to the first aspect, the clogged status is an output indicating one or more of a current clogged level of the air filter, a current capacity of the air filter, or an expected longevity of the air filter.

According to the first aspect, the clogged status may be one or more of a textual indicator and a percentage indicator.

According to a second aspect of the present disclosure, there is provided a system for displaying a clogged status for a vehicle air filter including one or more processors configured to determine an air flow rate through the air filter, determine an air quality level of a passenger cabin, determine an HVAC noise level for the passenger cabin, determine a differential pressure at the air filter, determine a power level for a blower motor, determine a temperature settling time for the passenger cabin, calculate a clogged status of the air filter based on the air flow rate, air quality level, HVAC noise level, differential pressure, power level for a blower motor, and temperature settling time, and display the clogged status on a display.

According to the second aspect, calculating a clogged status of the air filter is based on the air flow rate, air quality level, HVAC noise level, differential pressure, power level for a blower motor, and temperature settling time.

According to the second aspect, calculating a clogged status of the air filter further includes comparing the determined value to a predetermined threshold value.

According to the second aspect, the clogged status is an output indicating one or more of a current clogged level of the air filter, a current capacity of the air filter, or an expected longevity of the air filter.

According to a third aspect of the present disclosure, there is provided a vehicle including an air filter configured to filter air in a passenger cabin of the vehicle, a blower in communication with the air filter, a plurality of sensors, including at least one air flow rate sensor, at least one air quality sensor, at least one sound sensor, at least one differential pressure sensor, and at least one temperature sensor, one or more processors configured to receive a plurality of signals from the at least one air flow rate sensor, the at least one air quality sensor, the at least one sound sensor, the at least one differential pressure sensor, the blower, and the at least one temperature sensor, and calculate a clogged status of the air filter based on the plurality of signals received from the air flow rate sensor, the air quality sensor, the sound sensor, the differential pressure sensor, the blower, and the temperature sensor, and a display configured to receive an output from the one or more processors based on the clogged status of the air filter.

According to the third aspect, calculating a clogged status of the air filter further includes instructing the one or more processors to determine an air flow rate through the air filter based on signals received from the air flow rate sensor, determine an air quality level of a passenger cabin based on signals received from the air quality sensor, determine an HVAC noise level for the passenger cabin based on signals received from the sound sensor, determine a differential pressure at the air filter based on signals received from the differential pressure sensor, determine a power level for a blower motor based on signals received from the blower, determine a temperature settling time for the passenger cabin based on signals received from the temperature sensor, and compare each determined value to a predetermined threshold value.

According to the third aspect, the clogged status is an output indicating one or more of a current clogged level of the air filter, a current capacity of the air filter, and an expected longevity of the air filter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically illustrates a vehicle having an HVAC system according to a principle of the present disclosure;

FIG. 2 is a block diagram depicting the HVAC system and sensors according to a principle of the present disclosure; and

FIG. 3 is a flow chart depicting an example method for determining a clogged status of an air filter according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

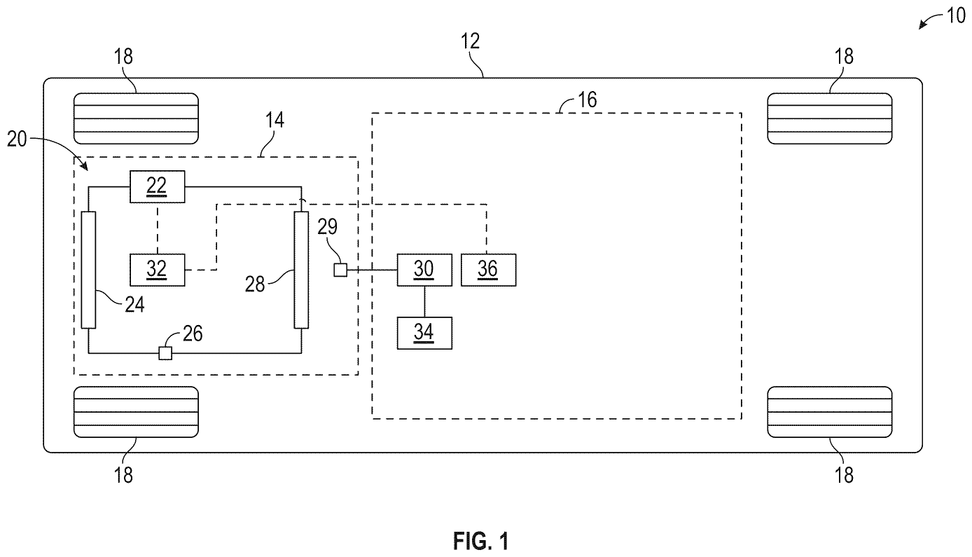

FIG. 1 schematically illustrates a vehicle 10 according to a principle of the present disclosure. Vehicle 10 includes a body 12 that defines an engine compartment 14 and a passenger cabin 16. Engine compartment 14 may house a propulsion system (not shown) that provides power to at least one wheel 18 of vehicle 10. Example propulsion systems (not shown) may include internal combustion engines, electrically-powered drive systems, and hybrid drive systems. Engine compartment 14 may also house a heating, ventilation, and air conditioning (HVAC) system 20 that includes a compressor 22, a first heat exchanger (i.e., condenser) 24, an expansion device 26 such as an expansion valve or capillary tube, and a second heat exchanger 28 (i.e., evaporator). While not shown in FIG. 1, it should be understood that HVAC system 20 may include additional components such as a dryer, accumulator, fan, and other components that are known to one skilled in the art.

HVAC system 20 is configured to provide heated and/or cooled air to passenger cabin 16 through at least blower 29 and one vent 30, as is known in the art. The vent 30 may further include an air filter 34. The air filter 34 may be a conventional air filter or a HEPA air filter.

HVAC system 20 may further include a controller 32 configured to control the components of the HVAC system 20. The controller 32 may be an electronic control unit (ECU) dedicated to the HVAC system. Alternatively, the controller 32 may be an ECU controlling multiple components throughout the vehicle 10.

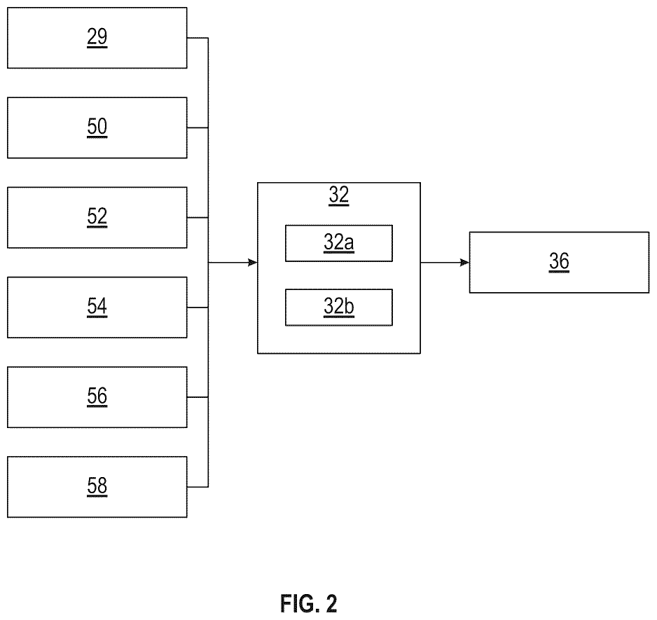

Referring to FIG. 2, the controller 32 may comprise at least one processor 32a and at least one memory 32b. The controller 32 may be in communication with to a plurality of sensors, including an air flow sensor 50, an air quality or dust sensor 52, a sound sensor 54, a differential pressure sensor 56, and a temperature sensor 58. The sensors 50, 52, 54, 56, 58 may be within or proximate to the passenger cabin 16. The controller 32 may further be in communication with the blower 29. Each sensor 50, 52, 54, 56, 58 and the blower 29 may send signals to the controller 32. These signals may include information regarding the air flow rate through the air filter 34, the air quality within the passenger cabin 16, the HVAC noise level, the differential pressure on the air filter 34, the power of the blower 29, and the settling time of the passenger cabin 16 (i.e., the amount of time it takes for the passenger cabin 16 to reach a chosen temperature). While the description refers to single sensors, it should be understood that each sensor 50, 52, 54, 56, 58 may be comprised of a plurality of sensors. For example, the differential pressure sensor 56 may include a differential pressure sensor 56 on the passenger cabin 16 side of the air filter 34 and another differential pressure sensor 56 on the HVAC system 20 side of the air filter 34. In this example, the controller 32 may be in communication with and receive signals from both differential pressure sensors 56. In this example, the controller 32 may determine a differential pressure value based on one or both differential pressure sensors 56.

The controller 32 may be in communication with a display 36. The controller 32 may be configured to output status information regarding the air filter 34 to the display 36. The display 36 may be a heads-up display (HUD), an infotainment system, an instrument panel, or other means of displaying information to vehicle occupants.

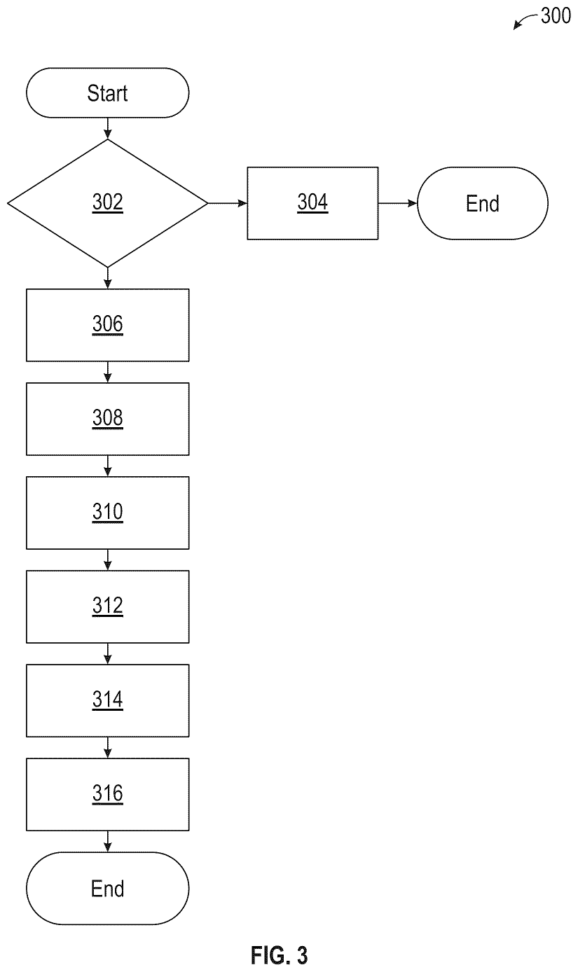

Referring to FIG. 3, a flow chart of an example method 300 of the present disclosure is shown.

At step 302, the controller 32 may evaluate the air flow rate through the air filter 34. The controller 32 may receive a signal from the air flow sensor 50 indicating the air flow rate. The controller 32 may compare the air flow rate to an air flow rate threshold. For example, if the air flow rate in a normally clean air filter 34 is 5 m/s and the air flow rate detected by air flow sensor 50 is only 3 m/s, it can be inferred that air filter 34 may be experiencing some clogging. In general, the air flow rate threshold can be selected to be 4 m/s. While the preceding example describes the air flow sensor measuring the air flow rate in terms of velocity, it should be understood that the air flow sensor may use different metrics like volume per unit time (e.g., m³/h), as is known in the art. If the air flow rate is above the air flow rate threshold, the air flow rate is acceptable and the controller 32 moves to step 304. If the air flow rate is below the air flow rate threshold, as in the above example, the air flow rate is unacceptable and the controller 32 moves to step 306. While the threshold value of this example is a singular value, it should be understood that the air flow rate threshold, and all of the threshold values in the application, may be a range of values.

At step 304, the controller 32 causes a healthy indicator to be displayed on the display 36. The healthy indicator may be a textual message that the air filter 34 is healthy (i.e., in a state of no or insignificant clogging). Alternatively, the healthy indicator may be a percentage. After completing step 304, the controller has identified that there is not a problem with the air flow rate and the method 300 can end. An above-threshold air flow rate indicates that there is unlikely to be a further concern with the air filter 34.

At step 306, the controller 32 may evaluate the air quality within the passenger cabin 16. The controller 32 may receive a signal from the air quality sensor 52 indicating the air quality value. The air quality sensor 52 may be a PM2.5 or PM10 particulate matter sensor, which can detect particulate matter having a particle size of 2.5 microns or 10 microns, respectively. The controller 32 may compare the air quality value to an air quality threshold value. For example, the controller 32 may determine an air quality value of 75 μg/m³ and compare this value against an air quality threshold value of 50 μg/m³. If the air quality value is greater than the air quality threshold value, as in the example, the controller 32 may determine that the air filter 34 is in a state of LOW clogging and the controller 32 moves to step 308. If the air quality value is less than the air quality threshold value, the air quality value is acceptable, and the controller moves to step 308.

At step 308, the controller 32 may evaluate the HVAC noise level. The controller 32 may receive a signal from the HVAC noise sensor 54 indicating the HVAC noise value. The HVAC noise sensor 54 may be located at different points in the vehicle. In one example, the HVAC noise sensor 54 may be located within the passenger cabin 16 and measure the HVAC noise (e.g., sounds emanating from the compressor 22, blower 29, air vents 30, etc.) in the passenger cabin 16 some distance from the air filter 34. In another example, the HVAC noise sensor 54 may be located proximate to the air filter 34. In either case, the HVAC noise threshold value may be chosen, at least in part, based on the expected HVAC noise level at the location of the HVAC sensor 54.

The controller 32 may compare the HVAC noise value to an HVAC noise threshold value. For example, the controller 32 may determine an HVAC noise value of 55 dB and the HVAC noise threshold value may be 60 dB. If the HVAC noise value is greater than the HVAC noise threshold value, the controller 32 may determine that the air filter 34 is in a state of MEDIUM clogging and the controller 32 moves to step 310. If the HVAC noise value is less than the HVAC noise threshold value, as in the example, the HVAC noise value is acceptable and the controller 32 moves to step 310.

At step 310, the controller 32 may evaluate the differential pressure level at the air filter 34. The differential pressure level is a measurement of the difference between the air pressure at the passenger cabin 16 side of the air filter 34 and the air pressure at the HVAC side of the air filter 34. The controller 32 may receive a signal from the differential pressure sensor 56 indicating the differential pressure value. The controller 32 may compare the differential pressure value to a differential pressure threshold value. For example, the controller 32 may determine a differential pressure value of 5 Pa and the differential pressure threshold value may be 0.5 Pa. If the differential pressure value is greater than the differential pressure threshold value, the controller 32 may determine that the air filter 34 is in a state of HIGH clogging and the controller 32 moves to step 312. If the differential pressure value is less than the differential pressure threshold value, the differential pressure value is acceptable and the controller 32 moves to step 312.

At step 312, the controller 32 may evaluate the power of the blower 29. The controller 32 may receive a signal from the blower 29 indicating the blower power value. The controller 32 may compare the blower power value to a blower power threshold value. For example, the controller 32 may determine a blower power value of 350 watts and the blower power threshold value may be 250 watts. If the blower power value is greater than the blower power threshold value, the controller 32 may determine that the air filter 34 is in a state of SEVERE clogging and the controller 32 moves to step 314. If the blower power value is less than the blower power threshold value, the blower power value is acceptable and the controller 32 moves to step 314.

At step 314, the controller 32 may evaluate the temperature settling time of the passenger cabin 16 (i.e., the amount of time it takes for the passenger cabin 16 to reach a chosen temperature). The chosen temperature may be determined by a vehicle occupant. The controller 32 may receive a plurality of signals over a span of time from the temperature sensor 58 monitoring the passenger cabin 16 indicating the temperature value. Based on these signals, the controller 32 may determine the settling time of the passenger cabin 16. The controller 32 may compare the settling time to a settling time threshold. For example, the controller 32 may determine a settling time of 5 minutes and the settling time threshold may be 2 minutes. If the settling time is greater than the settling time threshold, the controller 32 may determine that the air filter 34 is in a state of CRITICAL clogging and the controller 32 moves to step 316. If the settling time is less than the settling time threshold, the settling time is acceptable, and the controller 32 moves to step 316.

At step 316, the controller 32 causes an indicator of the current state of the air filter 34 to be displayed on the display 36. The current state of the air filter 34 may reflect the greatest severity determined by the controller 32. For example, if the controller 32 determined that the differential pressure at step 310 was unacceptable, but all determinations in subsequent steps were acceptable, then the controller 32 causes a HIGH clogging status indicator to be displayed on the display 36. The indicator may be a textual message indicating the current state of the air filter 34. Alternatively, the low clogging indicator may be a percentage. The controller 32 may further cause a recommendation to change the air filter 34 to be displayed on the display 32. For example, the controller 32 may cause a recommendation to change the air filter 34 SOON to be displayed if the controller 32 determined the clogging status of the air filter 34 to be HIGH, or IMMEDIATELY if the controller 32 determined the clogging status of the air filter 34 to be CRITICAL. The method 300 can end at this step.

The example method described in FIG. 3 may be executed by a request from a vehicle occupant. Alternatively, the example method may be executed periodically by the controller 32. In either case, the clogged status may be stored in memory for later retrieval and display by the controller 32 and may not be immediately displayed on the display 36.

In an alternative example, the controller 32 may evaluate air quality, HVAC noise, differential pressure, and blower power in a different order than presented in FIG. 3. For example, air quality may be evaluated after differential pressure or blower power may be evaluated after air flow rate. However, air flow rate is still evaluated first and settling time is still evaluated last.

In a further example, the HVAC system may include a carbon dioxide (CO2) sensor in the passenger cabin 16. The controller 32 may include, among the evaluation steps described in FIG. 3, a step of evaluating the CO2 level of the passenger cabin 16. Higher than expected CO2 levels in the passenger cabin 16 may indicate that the CO2 is not being removed from the air by the air filter 34 adequately. The controller 32 may compare the CO2 level of the passenger cabin 16 and a CO2 threshold value based on the number of occupants in the passenger cabin 16. If the CO2 value is greater than the CO2 threshold value, the CO2 value is unacceptable and the controller 32 may cause the display 36 to output a textual or percentage indicator of an unacceptable CO2 value. The controller 32 may further cause the HVAC system to automatically enter into a recirculation mode to reduce the CO2 level in the passenger cabin 16.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for displaying a clogged status for a vehicle air filter, comprising:
determining, by at least one processor of the vehicle, an air flow rate through the air filter;
determining, by the at least one processor, an air quality level of a passenger cabin;
determining, by the at least one processor, an HVAC noise level for the passenger cabin;
determining, by the at least one processor, a differential pressure at the air filter;
determining, by the at least one processor, a power level for a blower in communication with the air filter;
determining, by the at least one processor, a temperature settling time for the passenger cabin;
calculating, by the at least one processor, a clogged status of the air filter based on the air flow rate, the air quality level, the HVAC noise level, the differential pressure, the power level for a blower motor, and the temperature settling time; and
displaying the clogged status on a display.

2. The method according to claim 1, wherein calculating a clogged status of the air filter is based on the air flow rate, air quality level, HVAC noise level, differential pressure, power level for a blower motor, and temperature settling time.

3. The method according to claim 1, wherein the at least one processor is part of an Electronic Control Unit (ECU) in the vehicle.

4. The method according to claim 1, wherein determining, by the at least one processor, the air flow rate through the air filter further includes:
receiving, by the at least one processor, one or more signals from one or more air flow rate sensors, the one or more signals indicating a current air flow rate through the air filter.

5. The method according to claim 1, wherein determining, by the at least one processor, the air quality level of a passenger cabin further includes:
receiving, by the at least one processor, one or more signals from one or more air quality sensors, the one or more signals indicating a current air quality level in the passenger cabin.

6. The method according to claim 1, wherein determining, by the at least one processor, the HVAC noise level for the passenger cabin further includes:
receiving, by the at least one processor, one or more signals from one or more sound sensors, the one or more signals indicating a current HVAC noise level in the passenger cabin.

7. The method according to claim 1, wherein determining, by the at least one processor, the differential pressure at the air filter further includes:
receiving, by the at least one processor, one or more signals from one or more differential pressure sensors, the one or more signals indicating a current differential pressure at the air filter.

8. The method according to claim 1, wherein determining, by the at least one processor, the power level for the blower further includes:
receiving, by the at least one processor, one or more signals from the blower in communication with the air filter, the one or more signals indicating a current blower power level.

9. The method according to claim 1, wherein determining, by the at least one processor, the temperature settling time for the passenger cabin further includes:
receiving, by the at least one processor, one or more signals from one or more temperature sensors, the one or more signals indicating a current temperature in the passenger cabin; and
calculating, by the at least one processor, a current temperature settling time based on the one or more signals from the one or more temperature sensors over a predetermined range of time.

10. The method according to claim 1, wherein calculating a clogged status of the air filter further includes comparing, by the at least one processor, each determined value to a predetermined threshold value.

11. The method according to claim 1, wherein the clogged status is an output indicating one or more of:
a current clogged level of the air filter;
a current capacity of the air filter; or
an expected longevity of the air filter.

12. The method according to claim 11, wherein the clogged status may be one or more of a textual indicator and a percentage indicator.

13. A system for displaying a clogged status for a vehicle air filter comprising:
one or more processors configured to:
determine an air flow rate through the air filter;
determine an air quality level of a passenger cabin;
determine an HVAC noise level for the passenger cabin;
determine a differential pressure at the air filter;
determine a power level for a blower motor;
determine a temperature settling time for the passenger cabin;
calculate a clogged status of the air filter based on the air flow rate, air quality level, HVAC noise level, differential pressure, power level for a blower motor, and temperature settling time; and
display the clogged status on a display.

14. The system according to claim 13, wherein calculating a clogged status of the air filter is based on the air flow rate, air quality level, HVAC noise level, differential pressure, power level for a blower motor, and temperature settling time.

15. The system according to claim 13, wherein calculating a clogged status of the air filter further includes comparing the determined value to a predetermined threshold value.

16. The system according to claim 13, wherein the clogged status is an output indicating one or more of:
a current clogged level of the air filter;
a current capacity of the air filter; or
an expected longevity of the air filter.

17. The system according to claim 16, wherein the clogged status may be one or more of a textual indicator and a percentage indicator.

18. A vehicle comprising:
an air filter configured to filter air in a passenger cabin of the vehicle;
a blower in communication with the air filter;
a plurality of sensors, including at least one air flow rate sensor, at least one air quality sensor, at least one sound sensor, at least one differential pressure sensor, and at least one temperature sensor;
one or more processors configured to:
receive a plurality of signals from the at least one air flow rate sensor, the at least one air quality sensor, the at least one sound sensor, the at least one differential pressure sensor, the blower, and the at least one temperature sensor, and
calculate a clogged status of the air filter based on the plurality of signals received from the air flow rate sensor, the air quality sensor, the sound sensor, the differential pressure sensor, the blower, and the temperature sensor; and
a display configured to receive an output from the one or more processors based on the clogged status of the air filter.

19. The vehicle according to claim 18, wherein calculating a clogged status of the air filter further includes instructing the one or more processors to:
determine an air flow rate through the air filter based on signals received from the air flow rate sensor;
determine an air quality level of a passenger cabin based on signals received from the air quality sensor;
determine an HVAC noise level for the passenger cabin based on signals received from the sound sensor;
determine a differential pressure at the air filter based on signals received from the differential pressure sensor;
determine a power level for a blower motor based on signals received from the blower;
determine a temperature settling time for the passenger cabin based on signals received from the temperature sensor; and
compare each determined value to a predetermined threshold value.

20. The vehicle according to claim 18, wherein the clogged status is an output indicating one or more of:
a current clogged level of the air filter;
a current capacity of the air filter; and
an expected longevity of the air filter.
